(19) United States
(12) Patent Application Publication
(10) Pub. No.: US 2007/0293413 A1
(43) Pub. Date: Dec. 20, 2007

(54) Fabric softener composition

(75) Inventors: Kathryn McFarland, Durban North (ZA); Liezel Sabbagh, Johannesburg (ZA)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco Inc, d/b/a UNILEVER

(21) Appl. No.: 11/811,340

(22) Filed: Jun. 7, 2007

(30) Foreign Application Priority Data
Jun. 9, 2006 (GB) 0611486.2

(51) Int. Cl. C11D 3/00

(52) U.S. Cl. 510/515

(57) ABSTRACT

A stable, concentrated (pre-dilute) aqueous fabric softening composition having a viscosity of from 300 to 1000, preferably 300 to 850, more preferably 400 to 800 mPa·s at 116 s⁻¹ which composition is capable of being diluted with water in a 3:1 weight ratio of water:softening composition such that the resulting diluted softening composition is physically stable and has a viscosity of from 40 to 100 mPa·s at 116 s⁻¹, preferable 50 to 90 mPa·s at 116 s⁻¹, the composition comprising a) a cationic fabric softener b) 0.7 to 2.5% by weight of a cationic cross-linked polymer that is desirable from the polymerization of from 5 to 100 mole percent of cationic vinyl addition monomer, from 0 to 95 mole percent of acrylamide and from 50 to 1000 ppm, preferably 350 to 1000 ppm, more preferably 500 to 1000 ppm of a difunctional vinyl addition monomer cross-linking agent, c) from 0.001 to 0.2 by weight of electrolyte.

The present invention relates to concentrated fabric conditioning compositions, and more particularly to aqueous rinse-cycle concentrated fabric softener compositions containing a cationic polymer or mixture of cationic polymers, which concentrated compositions (pre-dilute) is capable of being diluted with water prior to use, e.g. in a 3:1 or more weight ratio of water to concentrate, to provide a physically stable softener composition in both the concentrated and diluted forms.

### FIELD OF INVENTION

Conventionally, most liquid fabric conditioning or fabric softener compositions make use of the thickening properties of surfactant ingredients or added salts to provide a desired rheology. More recently, the trend has been to incorporate specific thickeners into fabric softening compositions to provide a desired viscosity which remains stable over extended periods of time.

In commercial liquid fabric softener formulations the rheological properties of the product are critical for consumer acceptance. A common method of enhancing product appeal and conveying a perception of product richness and efficacy is to increase the apparent viscosity of the liquid product.

There are two key requirements for pre-dilute systems:
i) the product should incorporate some mechanism which thickens the dilute product. If the initial product is too viscous, it is unlikely the product will mix satisfactorily on dilution, e.g. the diluted product may be lumpy. If the initial product has a lower viscosity such that satisfactory dispersion is assured, the resulting dilute product would usually be very thin. In many markets consumers have been encouraged to associate high viscosity with product strength.
ii) after dilution, the resulting product must exhibit good viscostability and stability to separation, as the product will be kept for some time and be used over a good number of washes/rinses.

EP 394 133 discloses stable aqueous fabric softening compositions containing a di-long chain, di-short chain quaternary ammonium softening compound in combination with a fatty alcohol and a water-soluble polymer to improve the rheological properties and enhance the softening performance of the composition.

WO90/12862 discloses aqueous based fabric conditioning formulations comprising a water dispersible cationic softener and, as a thickener, a cross-linked cationic polymer that is derivable from a water soluble cationic ethylenically unsaturated monomer or blend of monomers, which is cross-linked by 5 to 45 ppm of a cross-linking agent comprising polyethylenic functions. An example of such a cross-linking agent is methylene bis acrylamide.

EP-A-0799887 discloses liquid fabric softening compositions which are said to exhibit an excellent viscosity and phase stability as well as softness performance, which compositions comprise:
(a) 0.01 to 10 weight % of a fabric softener component,
(b) at least 0.001% of a thickening agent selected from the group of:
   (i) associative polymers having a hydrophilic backbone and at least two hydrophobic groups per molecule attached to the hydrophilic backbone,
   (ii) the cross-linked cationic polymers described in the above mentioned WO90/12862, crosslinked by 5 to 45 ppm of crosslinking agent comprising polyethylenic functions and
   (iii) mixtures of (i) and (ii) and
(c) a component capable of sequestering metal ions.

WO02/057400 discloses fabric conditioning compositions containing cationic polymeric thickeners obtained by polymerising a water soluble cationic vinyl addition monomer, from 0 to 95 mole percent of acrylamide and from 70 to 300 ppm of difunctional vinyl addition monomer cross-linking agent. The thickened softening compositions are stated to be especially efficient for delivering fragrance in the softening composition to the treated fabrics.

WO2004/061066 discloses a stable concentrated aqueous fabric softening composition having a viscosity of from about 3000 cps to about 15,000 cps, preferably 4000 to 15000 cps, which composition is capable of being diluted with water in a 4:1 weight ratio of water to concentrated softening composition prior to use such that the resulting diluted softening composition is physically stable and has a medium viscosity of from about 90 cps to about 300 cps, said composition comprising:
(a) from about 5% to about 30% by weight of a cationic fabric softener
(b) at least about 0.01% by weight of:
   (i) a cationic linear homopolymer that is derivable from the polymerisation of acrylic acid and/or methacrylic acid; or
   (ii) a linear copolymer that is derivable from the polymerisation of acrylic acid and/or methacrylic acid and acrylamide or methacrylamide, said homopolymer or copolymer having a molecular weight of from about 10,000 to about 30 million; or
   (iii) a cationic crosslinked polymer that is derivable from the polymerisation of, from 5 to 100 mole percent of cationic vinyl addition monomer, from 0 to 95 mole percent of acrylamide, and from 70 ppm to 300 ppm of a difunctional vinyl addition monomer cross-linking agent; or
(c) at least about 0.01% by weight of a mixture of polymers comprising a cationic linear homopolymer or linear copolymer as defined in (i) or (ii) herein, respectively and a cationic crosslinked polymer as defined in (iii) herein the respective amounts of (i) or (ii) or (iii) in said concentrated softening composition being selected to provide the desired medium viscosity of from about 90 cps to about 300 cps in said diluted composition.

It has been found that there are problems in meeting the ideal viscosity requirements for a pre-dilute product. In particular, the amount of polymer thickener required to provide sufficient viscosity in the product after dilution may result in the product having an unacceptably high viscosity prior to dilution.

The invention has been made with the above point in mind.

### SUMMARY OF INVENTION

According to the invention there is provided a stable, concentrated (pre-dilute) aqueous fabric softening composition having a viscosity of from 300 to 1000, preferably 300 to 850, more preferably 400 to 800 mPa·s at 116 s⁻¹ which composition is capable of being diluted with water in a 3:1 weight ratio of water:softening composition such that the resulting diluted softening composition is physically stable and has a viscosity of from 40 to 100 mPa·s at 116 s⁻¹, preferable 50 to 90 mPa·s at 116 s⁻¹, the composition comprising
a) a cationic fabric softener
b) 0.7 to 2.5% by weight of a cationic cross-linked polymer that is derivable from the polymerization of from 5 to 100 mole percent of cationic vinyl addition monomer, from 0 to 95 mole percent of acrylamide and from 50 to 1000 ppm, preferably 350 to 1000 ppm, more preferably 500 to 1000 ppm of a difunctional vinyl addition monomer cross-linking agent,
c) from 0.001 to 0.2 by weight of electrolyte.

It has now surprisingly been found that the inclusion of a low level electrolyte, such as calcium chloride, can reduce the pre-dilution viscosity of a composition comprising a polymeric thickener without compromising the after dilution viscosity.

### DETAILED DESCRIPTION OF THE INVENTION

The compositions of the invention have a viscosity of from 300 to 1000, preferably 300 to 850, more preferably 400 to 800 mPa·s at 116 s⁻¹ enabling them to be dispersed from a container or sachet into a larger container for dilution, generally from 1:3 to 1:4 parts by weight composition:tap water. The resulting dilute compositions are stable and have a viscosity in the range 40 to 100, preferably 50 to 90 mPa·s at 116 s⁻¹ enabling the dilute compositions to be readily dosed into the rinse, e.g. via the drawer of an automatic washing machine.

Cationic Softening Agent

The cationic softening agent is generally one that is able to form a lamellar phase dispersion in water, in particular a dispersion of liposomes.

The cationic softening agent is typically a quaternary ammonium compound (“QAC”), in particular one having two C₁₂₋₂₈ groups connected to the nitrogen head group that may independently be alkyl or alkenyl groups, preferably being connected to the nitrogen head group by at least one ester link, and more preferably by two ester links.

The average chain length of the alkyl and/or alkenyl groups is preferably at least C₁₄ and more preferably at least C₁₆. It is particularly preferred that at least half of the groups have a chain length of C₁₋₈. In general, the alkyl and/or alkenyl groups are predominantly linear.

A first group of QACs suitable for use in the present invention is represented by formula (I): 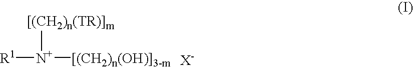
wherein each R is independently selected from a C₅₋₃₅ alkyl or alkenyl group; R¹ represents a C₁₋₄ alkyl, C₂₋₄ alkenyl or a C₁₋₄ hydroxyalkyl group; T is generally O—CO. (i.e. an ester group bound to R via its carbon atom), but may alternatively be CO.O (i.e. an ester group bound to R via its oxygen atom); n is a number selected from 1 to 4; m is a number selected from 1, 2, or 3; and X⁻ is an anionic counter-ion, such as a halide or alkyl sulphate, e.g. chloride or methylsulphate. Di-esters variants of formula I (i.e. m=2) are preferred and typically have mono- and tri-ester analogues associated with them. Such materials are particularly suitable for use in the present invention.

Especially preferred agents are di-esters of triethanolammonium methylsulphate, otherwise referred to as “TEA ester quats.”. Commercial examples include Prapagen TQL, ex Clariant, and Tetranyl AHT-1, ex Kao, (both di-[hardened tallow ester] of triethanolammonium methylsulphate), AT-1 (di-[tallow ester] of triethanolammonium methylsulphate), and L5/90 (di-[palm ester] of triethanolammonium methylsulphate), both ex Kao, and Rewoquat WE15 (a di-ester of triethanolammonium methylsulphate having fatty acyl residues deriving from C₁₀-C₂₀ and C₁₆-C₁₈ unsaturated fatty acids), ex Witco Corporation.

The second group of QACs suitable for use in the invention is represented by formula (II): 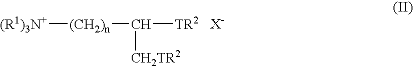
wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups; and wherein n, T, and X⁻ are as defined above.

Preferred materials of this second group include 1,2 bis[tallowoyloxy]-3-trimethylammonium propane chloride, 1,2 bis[hardened tallowoyloxy]-3-trimethylammonium propane chloride, 1,2-bis[oleoyloxy]-3-trimethylammonium propane chloride, and 1,2 bis[stearoyloxy]-3-trimethylammonium propane chloride. Such materials are described in U.S. Pat. No. 4,137,180 (Lever Brothers). Preferably, these materials also comprise an amount of the corresponding mono-ester.

A third group of QACs suitable for use in the invention is represented by formula (III):
(R¹)₂—N⁺—[(CH₂)ₙ-T-R²]₂ X⁻ (III)
wherein each R¹ group is independently selected from C₁₋₄ alkyl, or C₂₋₄ alkenyl groups; and wherein each R² group is independently selected from C₈₋₂₈ alkyl or alkenyl groups; and n, T, and X⁻ are as defined above. Preferred materials of this third group include bis(2-tallowoyloxyethyl)dimethyl ammonium chloride and hardened versions thereof.

A fourth group of QACs suitable for use in the invention is represented by formula (IV):
(R¹)₂—N⁺—(R²)₂X⁻ (IV)
wherein each R¹ group is independently selected from C₁₋₄ alkyl, or C₂₋₄ alkenyl groups; and wherein each R² group is independently selected from C₈₋₂₈ alkyl or alkenyl groups; and X⁻ is as defined above. Preferred materials of this fourth group include di(hardened tallow)dimethylammonium chloride.

The iodine value of the softening agent is preferably from 0 to 120, more preferably from 0 to 100, and most preferably from 0 to 90. Essentially saturated material, i.e. having an iodine value of from 0 to 1, is used in especially high performing compositions. At low iodine values, the softening performance is excellent and the composition has improved resistance to autoxidation and associated odour problems upon storage.

Iodine value is defined as the number of grams of iodine absorbed per 100 g of test material. NMR spectroscopy is a suitable technique for determining the iodine value of the softening agents of the present invention, using the method described in Anal. Chem., 34, 1136 (1962) by Johnson and Shoolery and in EP 593,542 (Unilever, 1993).

The softening agent is usually present in the compositions of the invention at a level of 2% to 75% by weight of the total composition. For even greater softening effect, this level may be 8% or greater; whilst for particularly high performance, this level may be 11% or greater. The level of softening agent is most preferably 10 to 30% by weight, e.g. 12.5 to 28% by weight.

References to levels of cationic softening agent in this specification are to the total level of cationic softening agent, including all cationic components of a complex raw material that could enter the aqueous lamellar phase together. With a di-ester softening agent, it includes any associated mono-ester or tri-ester components that may be present.

Cationic Cross-Linked Polymer

The cationic cross-linked polymer is derivable from the polymerization of from 5 to 100 mole percent of cationic vinyl addition monomer, from 0 to 95 mole percent of acrylamide and from 50 to 1000 ppm of a difunctional vinyl addition monomer cross-linking agent. Preferred polymers are cross-linked copolymers of acrylamide and methacrylate cross-linked with a difuncitonal vinyl addition monomer, such as methylene bisacrylamide. Particularly preferred polymers are copolymers of from about 20% acrylamide and about 80% MADAM methyl chloride (MADAM is dimethyl amino ethyl methacrylate) cross-linked with from 450 to 600 ppm of methylene bisacrylamide. Such materials are commercially available from SNF Floerger under the trade names Flosoft 200 and Flosoft 222.

The polymers are used in amounts of from 0.7 to 2.5, preferably from 1 to 2% by weight of the composition.

Supplementary Cationic Polymers

The compositions may additionally comprise additional cationic polymers to assist with viscosity control. Such polymers are generally used in amounts less then the cationic cross-linked polymer described above e.g. in a weight ratio of 1:2 to 1:5 supplementary polymer:cationic cross-linked polymer. Suitable supplementary polymers include non-acrylamide based polymers such as, Rheovis CDE commercially available from Ciba Speciality Chemicals.

Electrolyte

There may be trace amounts of electrolyte e.g. NaCl, present in the raw materials used to form the fabric softening compositions. However, in accordance with the invention additional electrolyte is added. The added electrolyte is present in an amount effective to provide a viscosity in the range from 300 to 1000 mPa·s at 116 s⁻¹. The precise concentration depends upon the electrolyte of choice and is generally in the range from 0.001 to 0.2% by weight, preferably 0.001 to 0.1%, more preferably 0.001 to 0.05% by weight of the compositions. A preferred electrolyte is CaCl₂ although other electrolytes, such as MgCl₂, NaCl etc may be used.

Fatty Co-Actives

A preferred additional component in the compositions of the present invention is a fatty co-active. Such agents typically have a C₈ to C₂₂ hydrocarbyl chain present as part of their molecular structure. Suitable fatty co-actives include C₈ to C₂₂ fatty alcohols and C₈ to C₂₂ fatty acids; of these, the C₈ to C₂₂ fatty alcohols are most preferred. A fatty co-active is particularly valuable in compositions comprising a QAC having a single C₁₂₋₂₈ group connected to the nitrogen head group, such as mono-ester associated with a TEA ester quat. or a softening agent of formula II, for reasons of product stability and effectiveness.

Preferred fatty acid co-actives include hardened tallow fatty acid (available as Pristerene, range ex Uniqema).

Preferred fatty alcohol co-actives include hardened tallow alcohol (available as Stenol and Hydrenol, ex Cognis, and Laurex CS, ex Albright and Wilson) and behenyl alcohol, a C₂₂ fatty alcohol, available as Lanette 22, ex Henkel.

These co-actives may be used at from 0.1% to 10%, particularly at from 0.5% to 5%, and especially at from 0.75 to 2% by weight, based on the total weight of the composition.

Other coactives, such as fatty esters, and fatty N-oxides may be used together with the cationic softening agent. When employed, they are typically present at from 0.1 to 20% and particularly at from 0.5 to 10%, based on the total weight of the composition.

Fatty esters that may be employed include fatty monoesters, such as glycerol monostearate, fatty sugar esters, such as those disclosed WO 01/46361 (Unilever).

Perfume

The compositions of the invention typically comprise one or more perfumes. The perfume is preferably present in an amount from 0.01 to 10% by weight, more preferably 0.05 to 5% by weight, most preferably 0.5 to 4.0% by weight, based on the total weight of the composition.

Further Optional Ingredients

The compositions of the invention may contain one or more other ingredients. Such ingredients include preservatives (e.g. bactericides), pH buffering agents, perfume carriers, fluorescers, colourants, hydrotropes, antifoaming agents, anti-redeposition agents, soil-release agents, polyelectrolytes, enzymes, optical brightening agents, anti-shrinking agents, anti-wrinkle agents, anti-spotting agents, anti-oxidants, sunscreens, anti-corrosion agents, drape imparting agents, anti-static agents, ironing aids and dyes.

A particularly preferred optional ingredient is an opacifier or pearlescer. Such ingredients can serve to further augment the creamy appearance of the compositions of the invention. Suitable materials may be selected from the Aquasol 0P30X range (ex Rohm and Haas), the PuriColour White range (ex Ciba) and the LameSoft™ range (ex Cognis). Such materials are typically used at a level of from 0.01 to 1% by weight of the total composition.

Aqueous Base

The compositions of the invention are typically aqueous. The aqueous base typically comprises 80% or greater by weight of water; sometimes this figure may rise to 90% or greater. The water in the aqueous base generally comprises 40% or greater by weight of the total formulation; preferably this figure is 60% or greater, more preferably it is 70% or greater.

Product Use

The products of the invention are concentrates or pre-dilutes intended to be diluted with water e.g. at 3:1 to 4:1 water:concentrate, and thereafter stored and used by the customer.

The diluted compositions of the present invention may be used in the rinse cycle of a domestic laundry process.

The diluted composition is preferably used in the rinse cycle of a home textile laundering operation, where, it may be added directly to a washing machine, e.g. through a dispenser drawer or, for a top-loading washing machine, directly into the drum. The compositions may also be used in a domestic hand-washing laundry operation.

It is also possible, though less desirable, for the diluted compositions of the present invention to be used in industrial laundry operations, e.g. as a finishing agent for softening new clothes prior to sale to consumers.

Manufacture

The compositions according to the invention may be prepared by any of the means known in the art. In a preferred method of manufacture of a fabric softening composition, a solution of the polymer is prepared independently of a dispersion of the cationic fabric softening agent and the separate components are then mixed to provide a composition according to the invention. In practice, the polymer solution is generally post-dosed into the dispersion with mixing at ambient temperature followed by the electrolyte to adjust the viscosity. Alternatively, after the dispersion of the pre-melted cationic fabric softening agent into an aqueous base, the polymer solution can be added hot using methods known in the art.

### EXAMPLES

The invention is further illustrated by the particular (non-limiting) examples described below. All amounts indicated are weight percentages of the total composition, unless otherwise indicated.

### Example 1

The following formulations were prepared.

| | Formulation | Control | Control | Control | |
|---|---|---|---|---|---|
| Component | 1 | 1 | 2 | 3 | Control 4 |
| DHTDMAC (1) | 15.2 | 15.2 | 15.2 | 15.2 | 15.2 |
| Pristerine | 2.6 | 2.6 | 2.6 | 2.6 | 2.6 |
| 4989 (2) | | | | | |
| Flosoft 200 (as | 1.5 | 1.5 | 0 | 0 | 0.5 |
| supplied, 50% | | | | | |
| Activity) (3) | | | | | |
| CaCl₂ | 0.02 | 0 | 0 | 0.07 | 0 |
| Formalin | 0.2 | 0.2 | 0.2 | 0.2 | 0.2 |
| Silicone AF9000 | 0.25 | 0.25 | 0.25 | 0.25 | 0.25 |
| Perfume | 0.9 | 0.9 | 0.9 | 0.9 | 0.9 |
| Dye | 0.04 | 0.04 | 0.04 | 0.04 | 0.04 |
| Water | 80.8 | 80.8 | 80.8 | 80.8 | 80.8 |
| Neat viscosity | 728 | 1010 | 314 | 13 | 609 |
| (mPas) | | | | | |
| Viscosity after | 57 | 55 | 2 | 1 | 10 |
| 1:3 dilution | | | | | |

(1) dihardened tallow dimethyl ammonium chloride (75% activity) under the trade name Noramium M2SH ex Ceca
(2) hardened tallow fatty acid ex Uniqema
(3) Flosoft 200 is commercially available from SNF Floerger.

Viscosities were measured on a Haake VT550 rheometer at 116 s⁻¹ (at 25° C.)
Method of Preparation

A concentrate base was prepared i.e. full formulation without polymer and electrolyte. The polymer was dosed as received with mixing using an overhead stirrer. CaCl₂ was then added as a 1.7% solution, with mixing continued for ca 30 min.

Dilution was performed by taking 500 g of product and diluting to 2000 g with ambient tap water, i.e. a 1:3 dilution.

### Example 2

The following formulation was prepared and tested as in Example 1

| Ingredients | % as is |
|---|---|
| DHTDMAC (1) | 15.2 |
| Pristerene 4989 | 2.6 |
| Flosoft 222 (2) | 2.3 |
| CaCl₂ | 0.1 |
| Formalin | 0.2 |
| Silicone AF | 0.25 |
| 9000 | |
| Perfume | 0.9 |
| Dye | Present |
| Water | to 100% |
| Viscosity Neat | 702 |
| Viscosity | 69 |
| dilute | |

(1) as in Example 1
(2) Flosoft 222 is commercially available from SNF Floerger.

What is claimed is:

1. A stable, concentrated (pre-dilute) aqueous fabric softening composition having a viscosity of from 300 to 1000, preferably 300 to 850, more preferably 400 to 800 mPa·s at 116 s⁻¹ which composition is capable of being diluted with water in a 3:1 weight ratio of water softening composition such that the resulting diluted softening composition is physically stable and has a viscosity of from 40 to 100 mPa·s at 116 s⁻¹, preferable 50 to 90 mPa·s at 116 s⁻¹, the composition comprising
a) a cationic fabric softener
b) 0.7 to 2.5% by weight of a cationic cross-linked polymer that is desirable from the polymerization of from 5 to 100 mole percent of cationic vinyl addition monomer, from 0 to 95 mole percent of acrylamide and from 50 to 1000 ppm, preferably 350 to 1000 ppm, more preferably 500 to 1000 ppm of a difunctional vinyl addition monomer cross-linking agent,
c) from 0.001 to 0.2 by weight of electrolyte.

2. An aqueous fabric softening composition as claimed in claim 1 in which the fabric softening compound is a quaternary ammonium compound.

3. An aqueous fabric softening composition as claimed in claim 2 in which the fabric softening compound comprises 2 C₁₂-C₂₈ alkyl or alkenyl groups.

4. An aqueous fabric softening composition as claimed in claim 1 in which the fabric softening compound comprises dihardened tallow dimethyl ammonium chloride.

5. An aqueous fabric softening compositions as claimed in claim 1 in which the fabric softening compound is present in an amount of from 5 to 30% by weight of the composition.

6. An aqueous fabric softening compositions as claimed in claim 5 in which the fabric softening compound is present in an amount of from 10 to 25% by weight of the composition.

7. An aqueous fabric softening composition as claimed in claim 1 which additionally comprises a fatty alcohol or fatty acid containing from 8 to 22 carbon atoms.

8. An aqueous fabric softening composition as claimed in claim 7 which comprises from 1 to 5% by weight of fatty acid.

9. An aqueous fabric softening composition as claimed in claim 1 in which the electrolyte is CaCl₂.

10. An aqueous fabric softening composition as claimed in claim 1 in which the electrolyte is present in an amount in the range from 0.001 to 0.1% by weight of the composition.
